(19) United States
(12) Patent Application Publication
(10) Pub. No.: US 2015/0292589 A1
(43) Pub. Date: Oct. 15, 2015

(54) SWITCHABLE/VARIABLE RATE ISOLATORS USING SHAPE MEMORY ALLOYS

(71) Applicant: GM Global Technology Operations LLC, Detroit, MI (US)

(72) Inventors: Michael E. McGuire, Milford, MI (US); Amy K. Luebke, Northville, MI (US); Charles C. Weddle, Waterford, MI (US)

(73) Assignee: GM Global Technology Operations LLC, Detroit, MI (US)

(21) Appl. No.: 14/250,974

(22) Filed: Apr. 11, 2014

(51) Int. Cl. F16F 1/36; F16F 15/06; F16F 15/08; F16F 1/02; B62D 7/22; F16F 15/00

(52) U.S. Cl. CPC F16F 1/3615; B62D 7/22; F16F 15/002; F16F 15/08; F16F 1/02; F16F 15/06; F16F 2222/02; F16F 2224/0258; F16F 2224/025; F16F 2228/066; F16F 2238/02

(57) ABSTRACT

A number of variations may include a product including a variable rate vibration isolator that may include a shape memory material having at least two physical states, wherein each physical state may have a corresponding vibration isolation rate. The vibration isolator may be disposed within and assembly including at least a first part and a voltage source in electrical communication with the shape memory alloy. The product may further include a controller constructed and arranged to pass at least one predetermined current from the voltage source to the shape memory alloy such that the shape memory alloy enters a physical state that dampens vibration of the first part.

### TECHNICAL FIELD

The field to which the disclosure generally relates to includes vibration isolation and shape memory materials.

### BACKGROUND

Isolators may be used to isolate an object or objects from a source of vibration, noise, or harshness.

### SUMMARY OF ILLUSTRATIVE VARIATIONS

A number of variations may include a product that may include a variable rate vibration isolator including a shape memory material that may have at least two physical states, wherein each physical state has a corresponding vibration isolation rate, disposed within an assembly including at least a first part and a voltage source in electrical communication with the shape memory material. The product may further include a controller constructed and arranged to pass at least one predetermined current from the voltage source to the shape memory material such that the shape memory material may enter a physical state thereby damping vibration of the first part.

Another variation may include a method that may include the steps of providing a variable rate vibration isolator that may include a shape memory material that may have at least two physical states, wherein each physical state may have a corresponding vibration isolation rate, a component assembly, a stimulus source, and a controller. The method may further include disposing the vibration isolator within the component assembly at a passive vibration isolation state having a passive vibration isolation rate. The method may further include monitoring the vibrations of the component assembly via the controller and providing a stimulus to the vibration isolator via the stimulus source when the component assembly undergoes undesirable vibration. The method may further include altering the shape memory material via the stimulus such that the shape memory material may enter a first active vibration isolation state having a first vibration isolation rate such that the vibration of the component is damped.

Another variation may include a method that may include the steps of providing a shape memory alloy having a passive base line vibration isolation state and at least one active vibration isolation state. The method may further include disposing the vibration isolator within a component assembly including at least a first part, monitoring the vibrations of the component assembly via the controller, providing a stimulus to the vibration isolator via the stimulus source when the component assembly undergoes undesirable vibration, altering the shape memory alloy via the stimulus such that the vibration of the component assembly is damped, and varying a vibration isolation rate of the first part, wherein stimulation of the shape memory alloy changes the isolation rate from the passive base line vibration isolation state to the at least one active vibration isolation state.

Other illustrative variations of the scope of the invention will become apparent from the detailed description provided hereinafter. It should be understood that the detailed description and enumerated variations, while disclosing optional variations, are intended for purposes of illustration only and are not intended to limit the scope of the invention.

### BRIEF DESCRIPTION OF THE DRAWINGS

Select examples of variations of the scope of the invention will become more fully understood from the detailed description and the accompanying drawings, wherein:

FIG. 1A depicts one variation according to a passive base line isolation state; and

FIG. 1B depicts one variation according to an active vibration isolation state.

### DETAILED DESCRIPTION OF ILLUSTRATIVE VARIATIONS

The following description of the variations is merely illustrative in nature and is in no way intended to limit the scope of the invention, its application, or uses.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

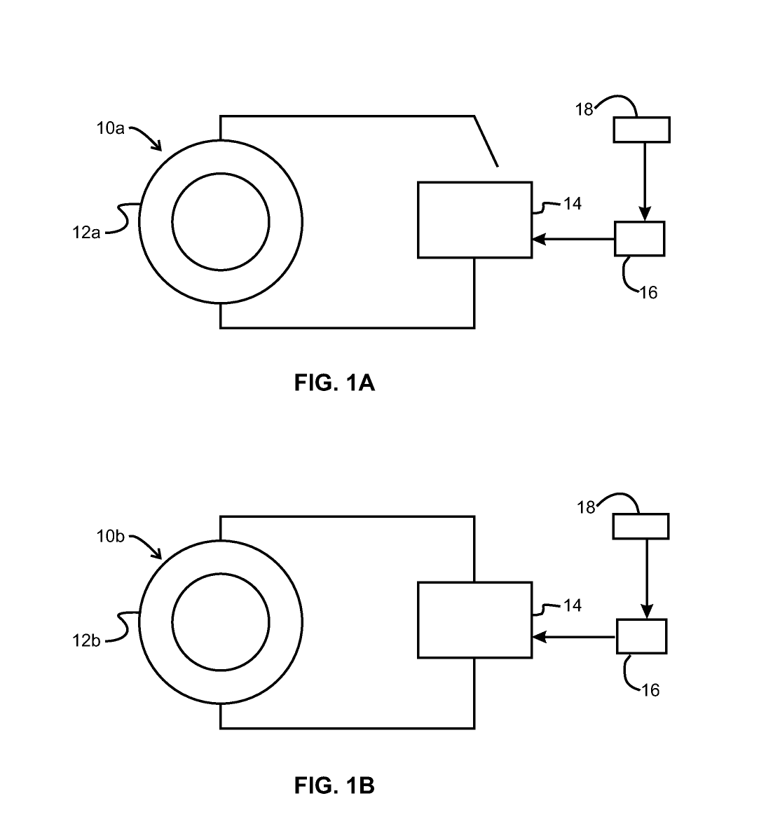

Referring to FIG. 1A, a variable rate vibration isolator 10a may include a shape memory material 12a. The variable rate vibration isolator 10a may further include a stimulus source 14. The stimulus source 14 may be in communication with the shape memory material 12a and may be constructed and arranged to provide a stimulus to the shape memory material 12a. A controller 16 may be in communication with the stimulus source 14 and the shape memory material 12a such that the controller may allow the stimulus source 14 to provide a stimulus to the shape memory material 12a under predetermined conditions. The controller 16 may receive input from the object to be isolated, the shape memory material 12a or 12b or one or more sensors 18 indicative of that vibration, noise or harshness that the object to be isolated, the shape memory material or one or more sensors is subjected to at a particular time. As best seen in FIG. 1A, where no stimulus is provided to the shape memory material 12a, the variable rate vibration isolator 10a may remain in a passive base line vibration isolation state having a corresponding passive vibration isolation rate.

Referring to FIG. 1B, the variable rate vibration isolator 10b may include a shape memory material 12b that has been stimulated by the stimulation source 14 via the controller 16. When a stimulus is applied to the variable rate vibration isolator 10b and the shape memory material 12b, the variable rate vibration isolator 10b may change into an active vibration isolation state having a corresponding active vibration isolation rate.

The vibration isolator may be constructed and arranged to fit within an assembly of parts or within an individual part and may have at least a passive base line vibration isolation state having a passive base line vibration isolation rate and at least one active vibration isolation state having at least one active vibration isolation rate. The vibration isolator may be of any shape or size as suitable for the application. The vibration isolator may be in communication with a stimulus source and a controller and may be constructed and arranged to change from at least a first passive base line vibration isolation state to any number of active vibration isolation states each having a corresponding active vibration isolation rate. When a stimulus is applied to the vibration isolator the shape memory material making up the vibration isolator may change its physical state, thereby also changing its vibration isolation rate. In this way, through the use of stimuli applied to the vibration isolator, the damping properties of the vibration isolator may be varied during use.

The stimulus source may be any number of devices suitable for providing a stimulus to the vibration isolator. As will be appreciated by one of ordinary skill in the art, the stimulus source may be constructed and arranged to apply an electrical current, a variation in temperature, a magnetic field, visible or non-visible light, a change in pH, or other external stimuli as appropriate to the shape memory material. The stimuli provided by the stimulus source may cause the shape memory material of the vibration isolator to change from a passive base line vibration isolation state to any number of active vibration isolation states or vice versa.

The controller 16 may be capable of processing sequential logic as well as combinational logic, may be included with the vibration isolator. Additionally, a device capable of reading data from memory and/or external storage devices may be in electrical communication with vibration isolator components including but not limited to the controller as well as additional controllers in communication with the vibration isolator. The controller may have onboard memory and may be in electrical communication with an external data storage device as well as external memory devices. The controller may be in electrical communication with any number of sensors, controllers, batteries, renewable energy sources or other electrical devices and may have the ability to store and timestamp data indicative of readings and/or signals from any number of sensors.

The assembly may include a first part, a second part, and may include any number of additional parts. The assembly may be any device or assembly of components that typically undergoes vibrational input during use. One of ordinary skill in the art will appreciate that the assembly may include, but is not limited to, automotive steering systems, pulse-width modulation controlled pumps and motors, electrically powered cooling fans and/or fan assemblies vibration absorption components, body mounts, and powertrain mounts. One of ordinary skill in the art will appreciate that the assembly may be any single part or combination of parts that undergoes noise, vibration, and harshness during use.

According to Variation 1, a product may include a variable rate vibration isolator that may include a shape memory material that may have at least two physical states, wherein each physical state may have a corresponding vibration isolation rate. The vibration isolator may be disposed within an assembly that may include at least a first part. The vibration isolator may further include a stimulus source in communication with the shape memory material. The vibration isolator may further include a controller constructed and arranged to pass at least one predetermined stimulus from the stimulus source to the shape memory material such that the shape memory material may change from a first physical state having a corresponding first vibration isolation rate to a second physical state having a corresponding second vibration isolation rate thereby damping vibration of the assembly.

Variation 2 may include a product as set forth in variation 1, wherein the controller may be constructed and arranged to monitor vibration, noise, and harshness of the assembly and may pass the at least one predetermined stimulus from the stimulus source to the shape memory material when vibration, noise, and harshness of the assembly has reached at least a predetermined value.

Variation 3 may include a product as set forth in variations 1 or 2, wherein the shape memory material may have at least three physical states, each physical state having a corresponding vibration isolation rate.

Variation 4 may include a product as set forth in any of variations 1-3, wherein the assembly is a steering system of an automobile.

Variation 5 may include a product as set forth in any of variations 1-3, wherein the assembly is a body mount on an automobile.

Variation 6 may include a product as set forth in any of variations 1-3, wherein the assembly may be a powertrain mount on an automobile.

Variation 7 may include a product as set forth in any of variations 1-6, wherein the shape memory material may be a shape memory alloy.

Variation 8 may include a product as set forth in any of variations 1-6, wherein the shape memory material may be a shape memory polymer.

Variation 9 may include a product as set forth in any of variations 1-8, wherein the stimulus source may be a voltage source and the stimulus may be current.

According to variation 10, a method may include providing a variable rate vibration isolator that may include a shape memory material having at least two physical states, wherein each physical state may have a corresponding vibration isolation rate, a component assembly, a stimulus source, and a controller. The method may further include disposing the vibration isolator within the component assembly, the vibration isolator being in a passive vibration isolation state having a corresponding passive vibration isolation rate. The method may further include monitoring vibrations of the component assembly via the controller, providing a stimulus to the vibration isolator via the stimulus source when the component assembly undergoes vibration, and altering the shape memory material via the stimulus such that shape memory material may enter a first active vibration isolation state having a first vibration isolation rate such that the vibration of the component assembly is damped.

Variation 11 may include a method as set forth in variation 10 further comprising the step of providing a second stimulus to the vibration isolator via the stimulus source when the component assembly undergoes vibration and altering the shape memory material via the stimulus such that the shape memory material may enter a second active vibration isolation state having a second vibration isolation rate such that the vibration of the component assembly is damped.

Variation 12 may include a method as set forth in any of variations 10-11 wherein the component assembly is a steering system of an automobile.

Variation 13 may include a product as set forth in any of variations 10-11 wherein the component assembly is a body mount of an automobile.

Variation 14 may include a method as set forth in any of variations 10-11 wherein the component assembly may be a powertrain mount on the automobile.

Variation 15 may include a method as set forth in any of variations 10-14 wherein the shape memory material is a shape memory alloy.

Variation 16 may include a method as set forth in any of variations 10-14 wherein the shape memory material may be a shape memory polymer.

According to variation 17, a method may include providing a shape memory alloy that may have a passive base line vibration isolation state and at least one active vibration isolation state; disposing the vibration isolator within a component assembly including at least a first part; monitoring the vibrations of the component assembly via the controller; providing a stimulus to the vibration isolator via a stimulus source when the component assembly undergoes vibration; altering the shape memory alloy via the stimulus such that the vibration of the component assembly is damped; and varying an isolation rate of vibrations of the first part, wherein the stimulation of the shape memory alloy changes the isolation rate from the passive base line vibration isolation state to the at least one active vibration isolation state.

Variation 18 may include a method as set forth in variation 17 wherein the passive base line vibration isolation state may include a passive base line vibration rate and the at least one active vibration isolation state may include at least one active base line vibration rate.

Variation 19 may include a method as set forth in variation 18, wherein the shape memory alloy may change the isolation rate between the passive base line vibration isolation rate and at least two or more active vibration isolation rates.

Variation 20 may include a method as set forth in variation 19 that may further include altering the shape memory alloy a second time via the stimulus wherein stimulation of the shape memory alloy returns the isolation rate from the at least one active vibration isolation rate to the passive base line vibration isolation rate.

Variation 21 may include a method as set forth in variation 20 that may further include altering the shape memory alloy via the stimulus wherein stimulation of the shape memory alloy changes the isolation rate to a second active vibration isolation rate.

The above description of select variations within the scope of the invention is merely illustrative in nature and, thus, variations or variants thereof are not to be regarded as a departure from the spirit and scope of the invention.

What is claimed is:

1. A product comprising:
a variable rate vibration isolator comprising a shape memory material having at least two physical states, wherein each physical state has a corresponding vibration isolation rate, disposed between an assembly comprising at least a first part and a stimulus source in communication with the shape memory material; and
a controller constructed and arranged to pass at least one predetermined stimulus from the stimulus source to the shape memory material such that the shape memory material changes from a first physical state having a corresponding first vibration isolation rate to a second physical state having a corresponding second vibration isolation rate that dampens vibration of the first part.

2. A product as set forth in claim 1, wherein the controller is constructed and arranged to monitor vibration, noise, and harshness of the assembly and passes the at least one predetermined stimulus from the stimulus source to the shape memory material when vibration, noise, and harshness of the assembly has reached at least predetermined value.

3. A product as set forth in claim 1, wherein the shape memory material has at least three physical states, each physical state having a corresponding vibration isolation rate.

4. The product of claim 1 wherein the assembly is a steering system of an automobile.

5. The product of claim 1 wherein the assembly is a body mount of an automobile.

6. The product of claim 1 wherein the assembly is a powertrain mount of an automobile.

7. The product of claim 1 wherein the shape memory material is a shape memory alloy.

8. The product of claim 1 wherein the shape memory material is a shape memory polymer.

9. The product of claim 1 wherein the stimulus source is a voltage source and the stimulus is electrical current.

10. A method comprising:
providing a variable rate vibration isolator comprising a shape memory material having at least two physical states, wherein each physical state has a corresponding vibration isolation rate, a component assembly, a stimulus source, and a controller;
disposing the vibration isolator of the component assembly at a passive vibration isolation state having a passive vibration isolation rate;
monitoring vibrations of the component assembly via the controller;
providing a stimulus to the vibration isolator via the stimulus source when the component assembly undergoes undesirable vibration; and
altering the shape memory material via the stimulus such that the shape memory material enters a first active vibration isolation state having a first vibration isolation rate such that vibration of the component assembly is damped.

11. The method of claim 10, further comprising:
providing a second stimulus to the vibration isolator via the stimulus source when the component assembly undergoes undesirable vibration; and
altering the shape memory material via the stimulus such that the shape memory material enters a second active vibration isolation state having a second vibration isolation rate such that vibration of the component assembly is damped.

12. The method of claim 10 wherein the component assembly is a steering system of an automobile.

13. The method of claim 10 wherein the component assembly is a body mount of an automobile.

14. The method of claim 10 wherein the component assembly is a powertrain mount of an automobile.

15. The product of claim 10 wherein the shape memory material is a shape memory alloy.

16. The product of claim 10 wherein the shape memory material is a shape memory polymer.

17. A method comprising:
providing a shape memory alloy having a passive baseline vibration isolation state and at least one active vibration isolation state;
disposing the vibration isolator of a component assembly comprising at least a first part;
monitoring vibrations of the component assembly via the controller;
providing a stimulus to the vibration isolator via a stimulus source when the component assembly undergoes undesirable vibration;
altering the shape memory alloy via the stimulus such that the vibration of the component assembly is damped;
varying an isolation rate of vibrations of the first part, wherein stimulation of the shape memory alloy changes the isolation rate from the passive baseline vibration isolation state to the at least one active vibration isolation state.

18. The method of claim 17 wherein the passive baseline vibration isolation state comprises a passive baseline vibration rate and the at least one active vibration isolation state comprises an active baseline vibration rate.

19. The method of claim 17 wherein the shape memory alloy changes the isolation rate between the passive baseline vibration isolation rate and at least two or more active isolation rates.

20. The method of claim 19, further comprising:
altering the shape memory alloy a second time via the stimulus wherein stimulation of the shape memory alloy returns the isolation rate from the at least one active vibration isolation rate to the passive baseline vibration isolation rate.

21. The method of claim 120, further comprising:
altering the shape memory alloy via the stimulus wherein stimulation of the shape memory alloy changes the isolation rate to a second active vibration isolation rate.
